(19) United States
(12) Patent Application Publication
(10) Pub. No.: US 2025/0126127 A1
(43) Pub. Date: Apr. 17, 2025

(54) ASSOCIATION OF CLOUD ACCOUNTS

(71) Applicant: VMware LLC, Palo Alto, CA (US)

(72) Inventors: Neeraj Jakhar, Rohtak (IN); Siddharth Sukumar Burle, Pune (IN)

(21) Appl. No.: 18/651,481

(22) Filed: Apr. 30, 2024

(30) Foreign Application Priority Data
Oct. 17, 2023 (IN) 202341070632

(51) Int. Cl. H04L 9/40

(52) U.S. Cl. CPC H04L 63/102; H04L 63/20

(57) ABSTRACT

Systems, apparatus, articles of manufacture, and methods are disclosed for association of cloud accounts by instantiating or executing machine-readable instructions to in response to a linking request, associate a first cloud account and a second cloud account, where the association causes changes made to the first cloud account to be propagated to the second cloud account, store the association in a database, monitor a configuration of the first cloud account, and after a change in the configuration information of the first cloud account, apply the configuration information corresponding to the first cloud account to the second cloud account.

### RELATED APPLICATIONS

This application claims priority to Indian Application No. 202341070632 filed Oct. 17, 2023, by VMware LLC, entitled “ASSOCIATION OF CLOUD ACCOUNTS,” which is hereby incorporated by reference in its entirety for all purposes.

### FIELD OF THE DISCLOSURE

This disclosure relates generally to cloud computing, and, more particularly, to the association of cloud accounts.

### BACKGROUND

In recent years, cloud accounts (e.g., registered user/entity accounts that facilitate access to cloud resources) have been used in the provisioning of virtual machines and cloud resources. The cloud accounts may have various policies that govern the usage of the provisioned virtual machines.

### BRIEF DESCRIPTION OF THE DRAWINGS

FIG. 1 is a schematic block diagram of an example environment 100 in which example account association circuitry 101 operates to link at least one cloud account to a plurality of cloud resources.

FIG. 2 is a block diagram of an example implementation of the association circuitry of FIG. 1.

FIG. 3 is an illustration of a plurality of associated cloud accounts which are arranged in organizational groupings.

FIG. 4A is a first portion of a first sequence diagram of the account association circuitry operating to associate a first cloud account to a second cloud account.

FIG. 4B is a second portion of the first sequence diagram of the account association circuitry operating to associate the first cloud account to the second cloud account.

FIG. 5A is a first portion of a second sequence diagram of the account association circuitry operating to associate the first cloud account to the second cloud account.

FIG. 5B is a second portion of the second sequence diagram of the account association circuitry operating to associate the first cloud account to the second cloud account.

FIG. 6 is a flowchart representative of example machine readable instructions and/or example operations that may be executed, instantiated, and/or performed by example programmable circuitry to implement the account association circuitry of FIG. 2 to link a first cloud account and a second cloud account.

FIG. 7 is a block diagram of an example processing platform including programmable circuitry structured to execute, instantiate, and/or perform the example machine readable instructions and/or perform the example operations of FIG. 6 to implement the account association circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIG. 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

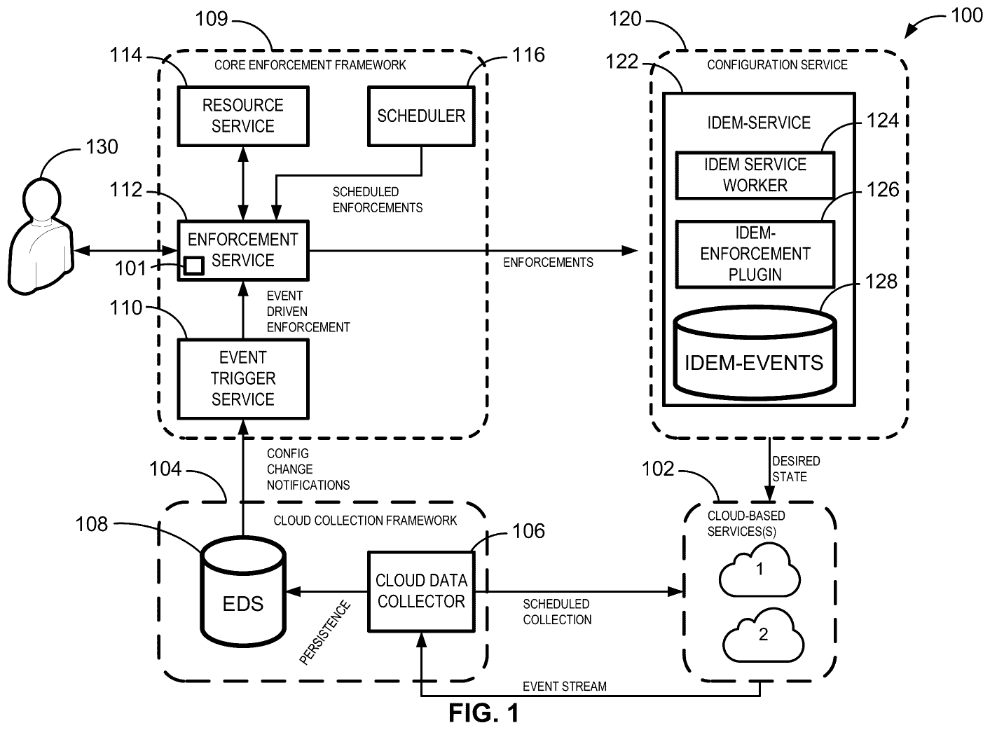

FIG. 1 is a schematic block diagram of an example environment 100 in which example account association circuitry 101 operates to link at least one cloud account to a plurality of cloud resources. The example account association circuitry 101 applies the enforcement policies of a first cloud account to a second cloud account that is linked to the first cloud account. As used herein, a cloud account is an object on a hardware system that represents a connection to a cloud service provider by using a particular set of credentials for access of cloud resources. For example, a cloud account is a container for cloud resources (e.g., deployable preconfigured collection of cloud resources). In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The architecture shown in the example of FIG. 1 is only an example and any other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 extracts, receives and/or queries information (e.g., components, metadata, services, service information) from the cloud-based service(s) 102. In this example, the cloud data collector 106 requests and/or directs the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110, the example enforcement service 112, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the example configuration service 120. For example, the scheduler 116 can schedule the enforcement service 112 to perform scheduled enforcements of the configuration service 120 which, in turn, controls and/or directs a desired state of the cloud-based service(s) 102.

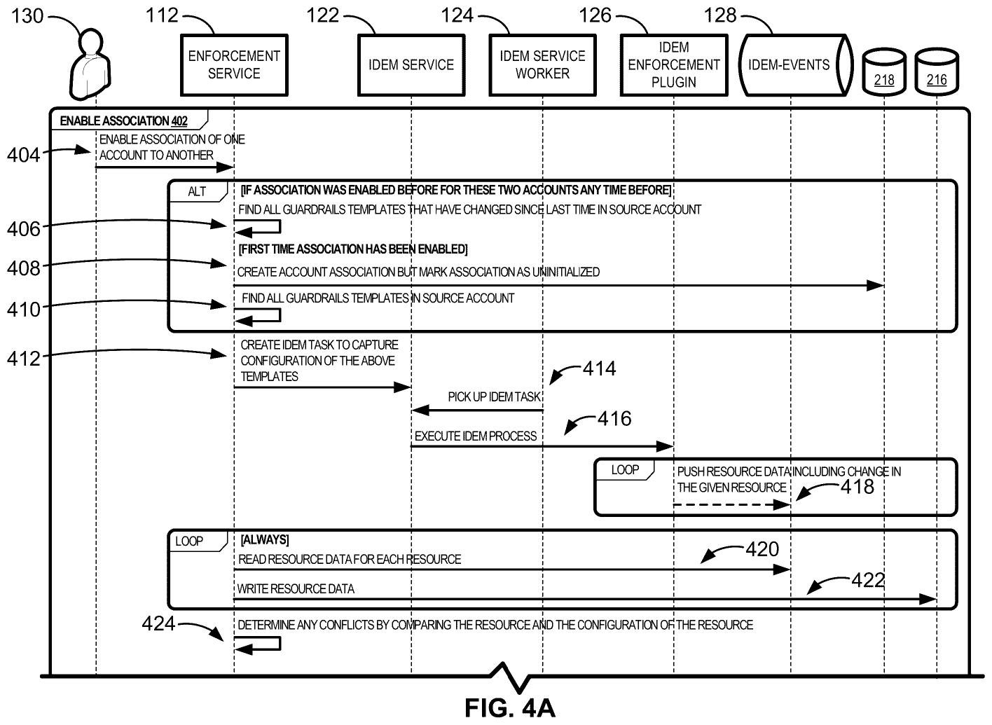

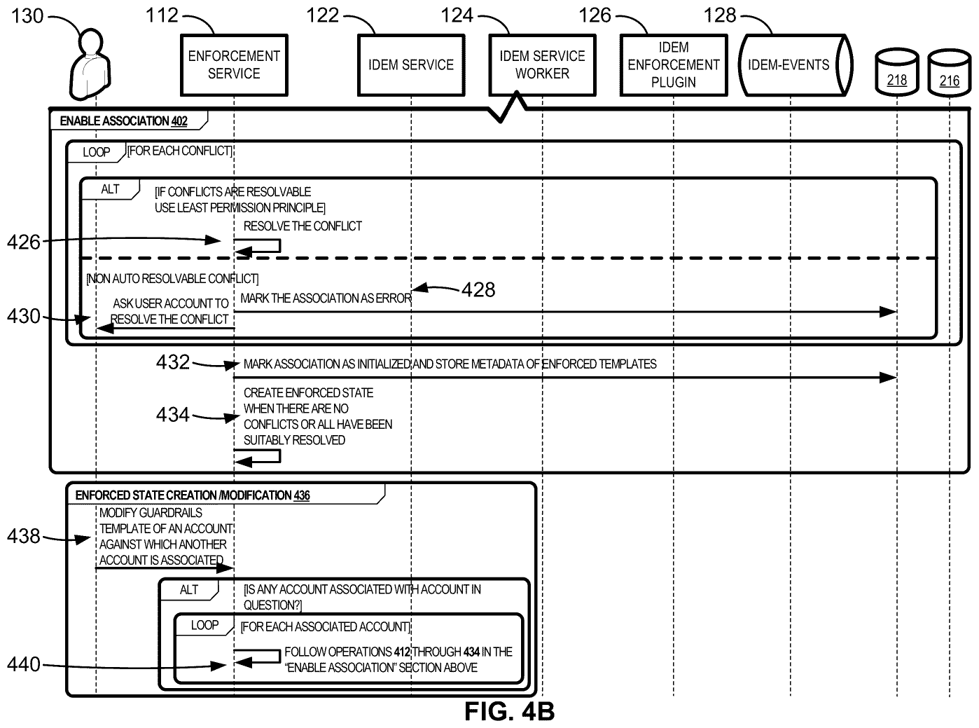

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service 122 that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation of a provisioning engine that implements desired state changes with respect to the cloud-based service(s) 102. In other words, the IDEM service 122 controls a desired state of the cloud-based service(s) 102 based on enforcements provided from the enforcement service 112. The example IDEM service 122 includes an example IDEM service worker 124, an example IDEM enforcement plugin 126, and an example IDEM-events database 128. In some examples, the IDEM-events database 128 is implemented by an APACHE® KAFKA® event-stream database. The example IDEM service 122, the example IDEM service worker 124, the example IDEM enforcement plugin 126, and the example IDEM-events database 128 are described in connection with FIGS. 4A-4B to assist the example enforcement service 122 in enforcing the target state of the cloud accounts.

While the account association circuitry 101 is shown implemented inside the example enforcement service 112, additionally or alternatively, the account association circuitry 101 can be implemented in the event trigger service 110, the resource service 114, the scheduler 116 and/or the configuration service 120.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services, examples disclosed herein can be implemented in conjunction with any appropriate distributed and/or shared computing resource system.

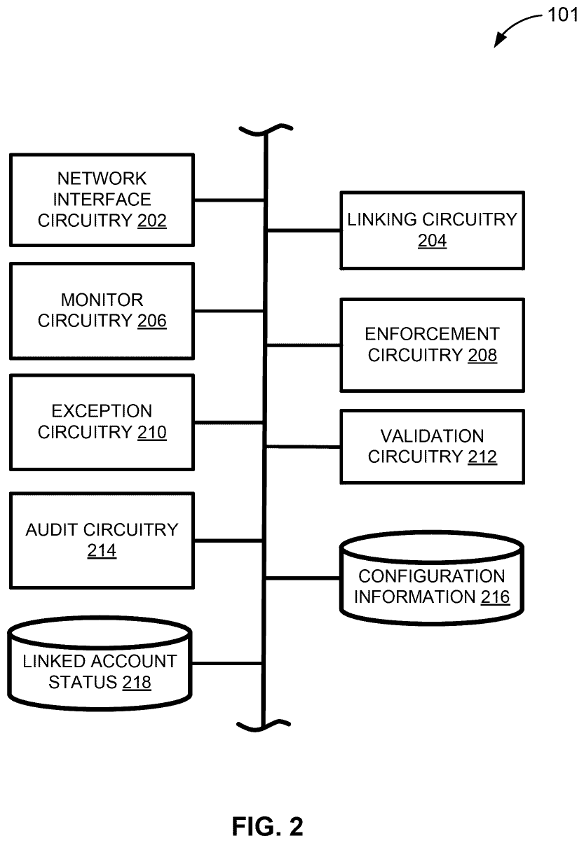

FIG. 2 is a block diagram of an example implementation of the account association circuitry 101 of FIG. 1 to link multiple cloud accounts. The account association circuitry 101 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the account association circuitry 101 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The account association circuitry 101 includes example network interface circuitry 202, example linking circuitry 204, example monitor circuitry 206, example enforcement circuitry 208, example exception circuitry 210, example validation circuitry 212, example audit circuitry 214, an example configuration information database 216, and an example linked account status database 218.

The example network interface circuitry 202 is to access (e.g., retrieve, obtain, receive, transmit, etc.) data. In some examples, the network interface circuitry 202 accesses requests from users to associate a first cloud account to a second cloud account or dissociate (e.g., remove the association, remove the linked status, etc.) the first cloud account from the second cloud account. For example, the network interface circuitry 202 allows for communications over any suitable wired and/or wireless network(s) including, for example, one or more data buses, one or more Local Area Networks (LANs), one or more wireless LANs, wide area network, a cloud, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events. In some examples, the network interface circuitry 202 is to communicate with the example configuration service 120.

The example linking circuitry 204 is to associate a first cloud account to a second cloud account. As used herein, to associate a first account to a second account is to link (e.g., peg, tag, connect, relate, etc.) the first account and the second account where changes made to the first cloud account are propagated (e.g., applied) to the second cloud account. The example linking circuitry 204 is to dissociate (e.g., remove an association, separate, detach, disconnect, depeg, etc.,) the first cloud accounts and the second cloud accounts. For example, the linking circuitry 204 may be used to dissociate the two cloud accounts, to allow a user account to perform further development on the first cloud account. If the two cloud accounts are linked, then the configuration information is replicated from the first cloud account to the second cloud account. In some examples, the linking circuitry 204 is able to link cloud accounts across different cloud vendors (e.g., Amazon Web Services®, Microsoft Azure®, Google Cloud Platform™, etc.).

In some examples, the link between a first cloud account and a second cloud account is directional. In such examples, a directional link assigns the first cloud account as a reference cloud account (e.g., source account) and assigns the second cloud account as a flexible cloud account that can be adapted based on the changes made to the reference cloud account. In some examples, the linking circuitry 204 applies a first directional link from the first cloud account to the second cloud account and applies a second directional link from the second cloud account to the first cloud account. In some examples, the linking circuitry 204 associates a second cloud account (e.g., a first flexible cloud account) and a third cloud account (e.g., a second flexible cloud account) to the first cloud account (e.g., the reference cloud account). The linking circuitry 204 is to store the association (e.g., the link) between the cloud accounts in the linked account status database 218.

The example monitor circuitry 206 is to monitor (e.g., manage, observe, check) the cloud accounts. For example, the monitor circuitry 206 may monitor the cloud accounts to determine the configuration information of the cloud accounts. The example monitor circuitry 206 determines the configuration information based on the configuration information database 216 which corresponds to the cloud accounts. For example, an enforcement policy may be applied to the configuration information (e.g., configuration state, configuration data, etc.) of the cloud account. Some of the enforcement policies include key rotation after a specific time interval (e.g., ninety days), elimination of unused resources, prevention of the creation of large virtual machines (e.g., a virtual machine over two gigabytes of RAM), monetary budget analysis, virtual machine performance anomaly checks, encryption of cloud resources. The enforcement policies may belong to a different category such as configuration, observation, cost, and security.

Multiple enforcement policies may be applied to a virtual machine, cloud resource instance, or cloud account. For example, the monitor circuitry 206 may determine that a first enforcement policy (e.g., a first guardrail offered by VMware's Guardrails® enforcement service) is applied to the first cloud account or the cloud resources of the first cloud account. In some examples, the monitor circuitry 206 determines that a first enforcement policy, a second enforcement policy, and a fourth enforcement policy are applied to a first unlinked cloud account, and the first enforcement policy and the third enforcement policy are applied to a second unlinked cloud account. In such examples, if the linking circuitry 204 stores an association that links the first unlinked cloud account to the second unlinked cloud account, the monitor circuitry 206 determines that the configuration of the two cloud accounts are different. The example monitor circuitry 206 informs the example enforcement circuitry 208 to change the configuration to reflect the association.

The example enforcement circuitry 208 is to enforce the configuration of the cloud accounts. For example, the enforcement circuitry 208 may rotate a key after a time period has elapsed for a first cloud account if the key rotation enforcement policy is applied on the first cloud account. In some examples, the enforcement circuitry 208 compares the first cloud account with a reference file (e.g., target state, desired state). In such examples, if a user account attempts to change the first cloud account to deviate from the reference file, the example enforcement circuitry 208 corrects the deviation and sets the first cloud account to correspond to the reference file. In some examples, if a first cloud account (e.g., reference account, source account) is linked to a second cloud account (e.g., flexible account), and the reference file of the first cloud account changes to add a first enforcement policy to the first cloud account, the example enforcement circuitry 208 adds the first enforcement policy to the second cloud account.

By linking the cloud accounts, and then enforcing the target state of the cloud accounts, the example enforcement circuitry 208 facilitates compliance with security guidelines, reduces costs, coordinates resources (e.g., allocation, utilization, and monitoring) of various cloud accounts, and manages data across different regions and backups. The example enforcement circuitry 208 reduces a cloud account sprawl by governing the creation of various cloud accounts from a central location without random users independently creating cloud accounts. Furthermore, the enforcement circuitry 208 with the example monitor circuitry 206 is to monitor the individual cloud accounts and then enforce compliance.

The example exception circuitry 210 is to notify a user account if there is an error in applying the configuration state information of the first cloud account to the configuration state information of the second cloud account. For example, the first cloud account may have a first enforcement policy (e.g., key rotation after ninety days) and before the second cloud account is associated to the first cloud account, the second cloud account already has a second enforcement policy (e.g., key rotation after sixty days). In such examples, after the association of the two cloud accounts, if the enforcement circuitry 208 is unable to simultaneously apply the first enforcement policy and the second enforcement policy, the example exception circuitry 210 notifies the user account of the error. The example user account may transmit an instruction to the example exception circuitry 210 on how to resolve the error (e.g., select the first enforcement policy).

The example validation circuitry 212 is to resolve errors in applying the configuration. For example, the validation circuitry 212 may use a privilege protocol (e.g., a least privilege protocol) to determine which of the conflicting enforcement policies are to be applied to the second cloud account. For example, a first user account may have a higher privilege level than a second user account. In such examples, based on the privilege protocol, the example validation circuitry 212 is to apply an instruction from the first user account. In some examples, the validation circuitry 212 compares the enforcement policies that are on the cloud accounts to determine if the enforcement policies are the same, similar, or conflicting. In such examples, the validation circuitry 212 may use a hash value of the enforcement policy to determine a similarity of the enforcement policy with another enforcement policy. In some examples, the validation circuitry 212 uses access control, creates IAM policies, roles, and permissions for each environment so that only authorized user accounts can access the cloud resources. For example, the validation circuitry 212 is to limit the permission granted to some user accounts based on a PO: P protocol.

The example audit circuitry 214 is to provide a history of the cloud accounts. For example, the history of the cloud accounts may include a list of the enforcement policies that are on the ones of the cloud accounts. In some examples, the history of the cloud accounts includes the various linkages and associations of the ones of the cloud accounts. For example, a first cloud account may be linked to a second cloud account for a first time period (e.g., three days), then unlinked from the second cloud account for a second time period (e.g., two days), before being relinked. During the interim unlinked time period, the second cloud account may be changed to include a different number of enforcement policies. The example audit circuitry 214 reports such history.

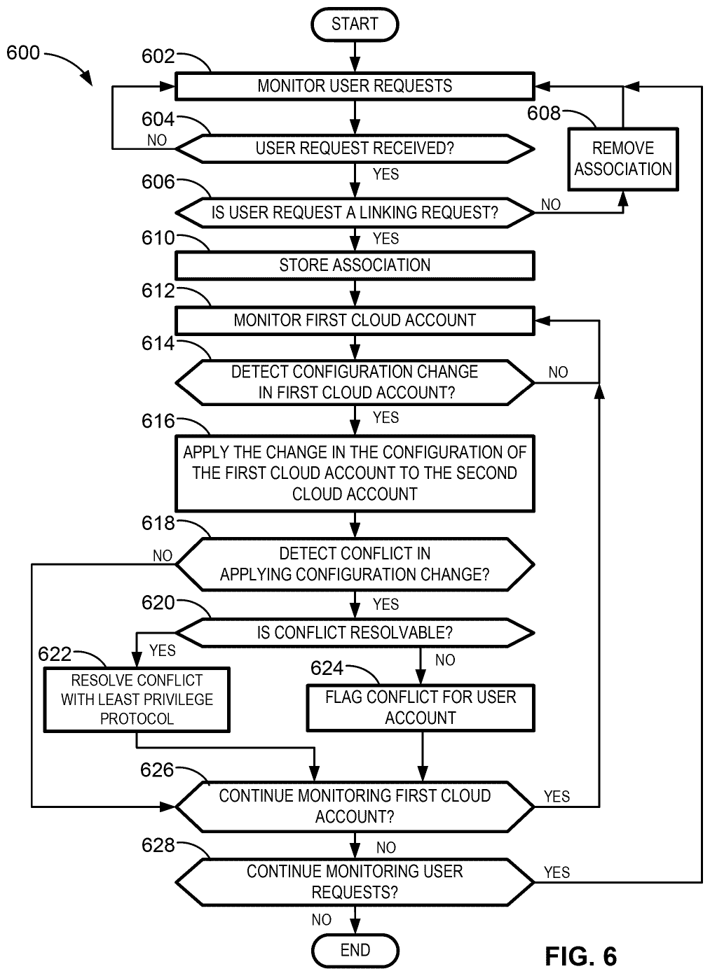

In some examples, the network interface circuitry 202 is instantiated by programmable circuitry executing network interface instructions and/or configured to perform operations such as those represented by the flowchart of FIG. 6.

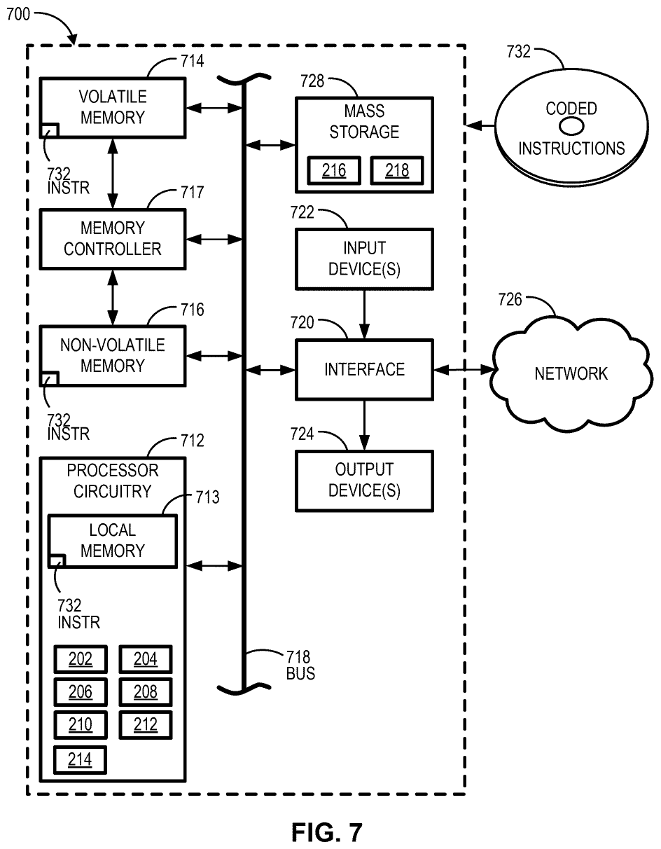

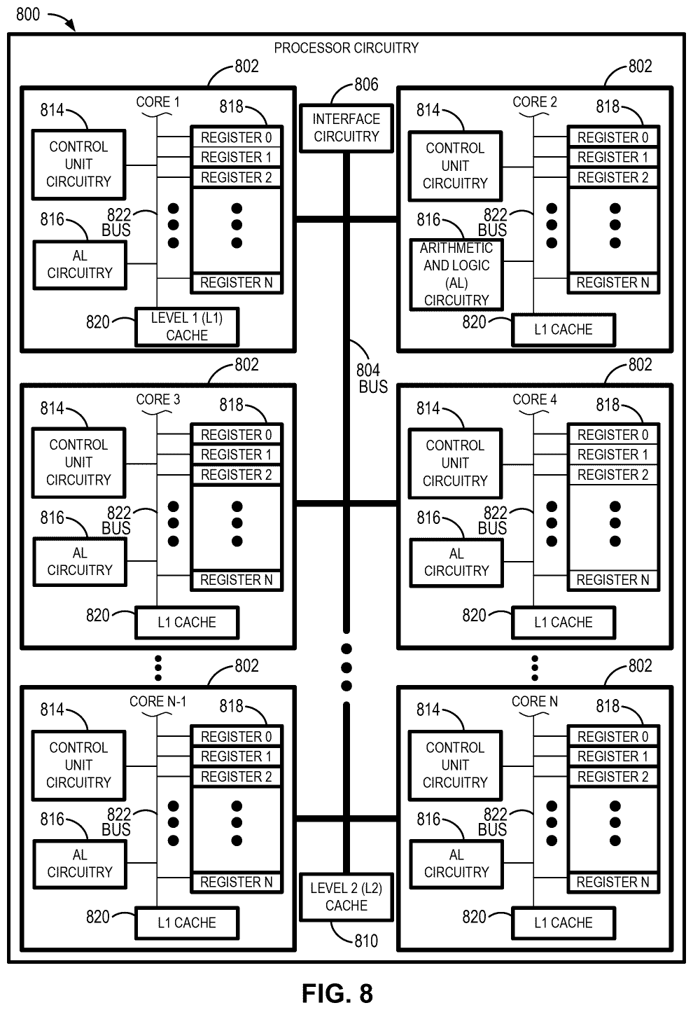

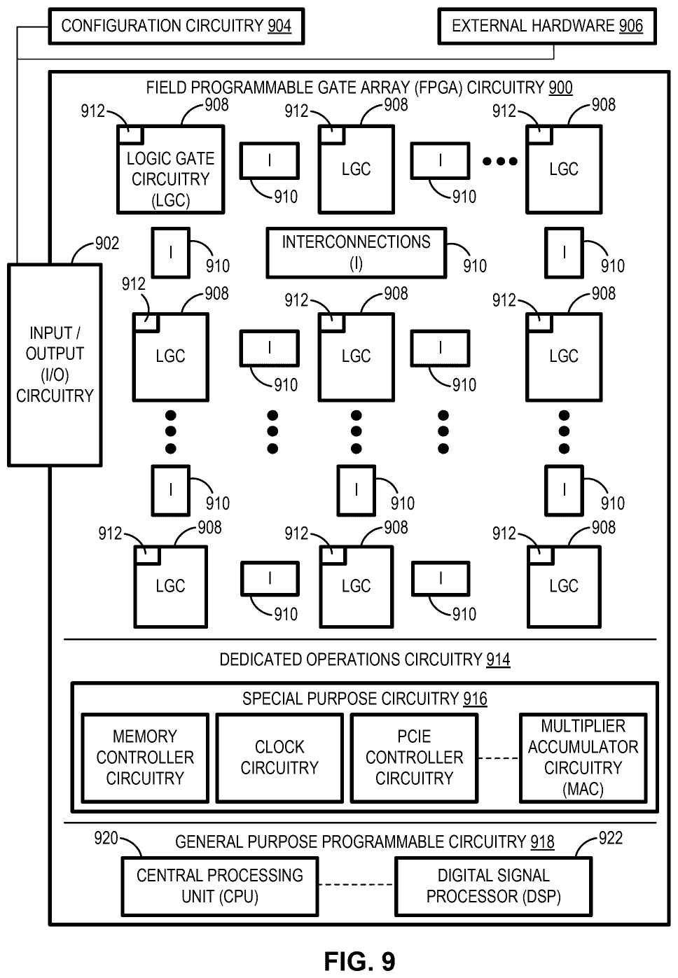

In some examples, the account association circuitry 101 includes means for accessing user requests. For example, the means for accessing may be implemented by network interface circuitry 202. In some examples, the network interface circuitry 202 may be instantiated by programmable circuitry such as the example programmable circuitry 712 of FIG. 7. For instance, the network interface circuitry 202 may be instantiated by the example microprocessor 800 of FIG. 8 executing machine executable instructions such as those implemented by at least block 602 of FIG. 6. In some examples, the network interface circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the network interface circuitry 202 may be instantiated by any other combination of hardware, software, and/or firmware. For example, the network interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the linking circuitry 204 is instantiated by programmable circuitry executing linking instructions and/or configured to perform operations such as those represented by the flowchart of FIG. 6.

In some examples, the account association circuitry 101 includes means for linking cloud accounts. For example, the means for linking may be implemented by linking circuitry 204. In some examples, the linking circuitry 204 may be instantiated by programmable circuitry such as the example programmable circuitry 712 of FIG. 7. For instance, the linking circuitry 204 may be instantiated by the example microprocessor 800 of FIG. 8 executing machine executable instructions such as those implemented by at least blocks 604, 606, 608, 610, and 628 of FIG. 6. In some examples, the linking circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the linking circuitry 204 may be instantiated by any other combination of hardware, software, and/or firmware. For example, the linking circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the monitor circuitry 206 is instantiated by programmable circuitry executing monitoring instructions and/or configured to perform operations such as those represented by the flowchart of FIG. 6.

In some examples, the account association circuitry 101 includes means for monitoring configuration information corresponding to cloud accounts. For example, the means for monitoring may be implemented by monitor circuitry 206. In some examples, the monitor circuitry 206 may be instantiated by programmable circuitry such as the example programmable circuitry 712 of FIG. 7. For instance, the monitor circuitry 206 may be instantiated by the example microprocessor 800 of FIG. 8 executing machine executable instructions such as those implemented by at least blocks 612, 614, and 626 of FIG. 6. In some examples, the monitor circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the monitor circuitry 206 may be instantiated by any other combination of hardware, software, and/or firmware. For example, the monitor circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the enforcement circuitry 208 is instantiated by programmable circuitry executing enforcement instructions and/or configured to perform operations such as those represented by the flowchart of FIG. 6.

In some examples, the account association circuitry 101 includes means for enforcing target configuration states of cloud accounts. For example, the means for enforcing may be implemented by enforcement circuitry 208. In some examples, the enforcement circuitry 208 may be instantiated by programmable circuitry such as the example programmable circuitry 712 of FIG. 7. For instance, the enforcement circuitry 208 may be instantiated by the example microprocessor 800 of FIG. 8 executing machine executable instructions such as those implemented by at least block 616 of FIG. 6. In some examples, the enforcement circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the enforcement circuitry 208 may be instantiated by any other combination of hardware, software, and/or firmware. For example, the enforcement circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the exception circuitry 210 is instantiated by programmable circuitry executing exception instructions and/or configured to perform operations such as those represented by the flowchart of FIG. 6.

In some examples, the account association circuitry 101 includes means for notifying a user account regarding an unresolvable conflict. For example, the means for notifying may be implemented by exception circuitry 210. In some examples, the exception circuitry 210 may be instantiated by programmable circuitry such as the example programmable circuitry 712 of FIG. 7. For instance, the exception circuitry 210 may be instantiated by the example microprocessor 800 of FIG. 8 executing machine executable instructions such as those implemented by at least block 624 of FIG. 6. In some examples, the exception circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the exception circuitry 210 may be instantiated by any other combination of hardware, software, and/or firmware. For example, the exception circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the validation circuitry 212 is instantiated by programmable circuitry executing validation instructions and/or configured to perform operations such as those represented by the flowchart of FIG. 6.

In some examples, the account association circuitry 101 includes means for resolving conflicts. For example, the means for resolving may be implemented by validation circuitry 212. In some examples, the validation circuitry 212 may be instantiated by programmable circuitry such as the example programmable circuitry 712 of FIG. 7. For instance, the validation circuitry 212 may be instantiated by the example microprocessor 800 of FIG. 8 executing machine executable instructions such as those implemented by at least blocks 618, 620, and 622 of FIG. 6. In some examples, the validation circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the validation circuitry 212 may be instantiated by any other combination of hardware, software, and/or firmware. For example, the validation circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the audit circuitry 214 is instantiated by programmable circuitry executing auditing instructions and/or configured to perform operations such as those represented by the flowchart of FIG. 6.

In some examples, the account association circuitry 101 includes means for auditing configuration changes made to cloud accounts. For example, the means for auditing may be implemented by audit circuitry 214. In some examples, the audit circuitry 214 may be instantiated by programmable circuitry such as the example programmable circuitry 712 of FIG. 7. For instance, the audit circuitry 214 may be instantiated by the example microprocessor 800 of FIG. 8 executing machine executable instructions such as those implemented by at least block 610 of FIG. 6. In some examples, the audit circuitry 214 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the audit circuitry 214 may be instantiated by any other combination of hardware, software, and/or firmware. For example, the audit circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the account association circuitry 101 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface circuitry 202, the example linking circuitry 204, the example monitor circuitry 206, the example enforcement circuitry 208, the example exception circuitry 210, the example validation circuitry 212, the example audit circuitry 214, and/or, more generally, the example account association circuitry 101 of FIG. 2, may be implemented by hardware alone or by hardware in combination with software and/or firmware. Thus, for example, any of the example network interface circuitry 202, the example linking circuitry 204, the example monitor circuitry 206, the example enforcement circuitry 208, the example exception circuitry 210, the example validation circuitry 212, the example audit circuitry 214, and/or, more generally, the example account association circuitry 101, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example account association circuitry 101 of FIG. 2 may include one or more elements, processes, and/or devices in addition to, or instead of, those illustrated in FIG. 2, and/or may include more than one of any or all of the illustrated elements, processes and devices.

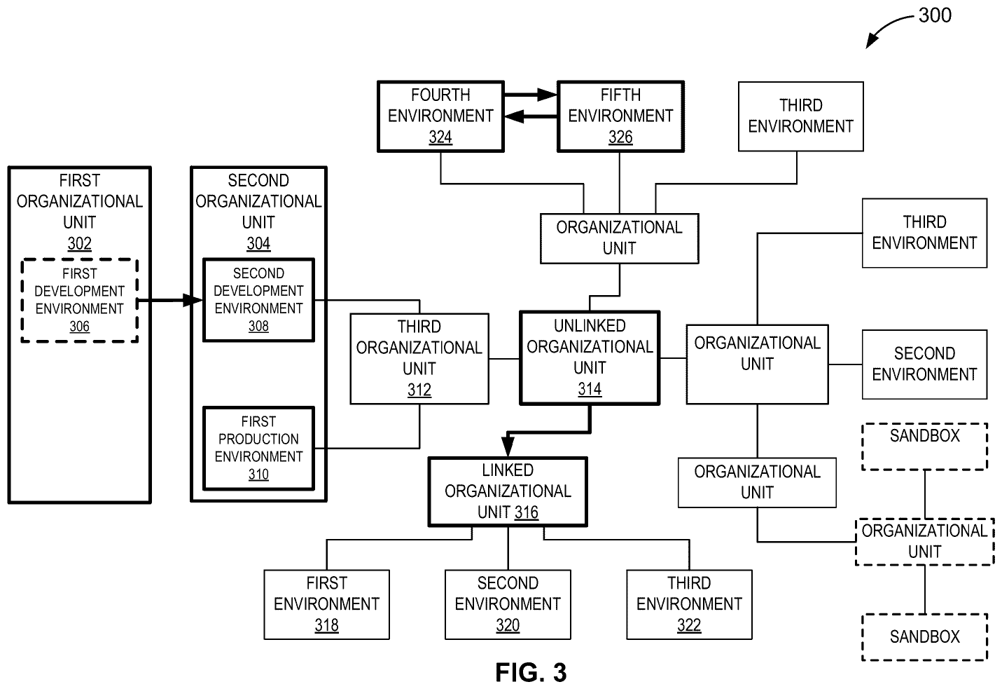

FIG. 3 is an illustration 300 of a plurality of associated cloud accounts (e.g., cloud environments, cloud subscriptions) which are arranged in organizational groupings (e.g., organizational units). FIG. 3 labels an example first organizational unit 302, an example second organizational unit 304, a first development environment 306, a second development environment 308, a first production environment 310, a third organizational unit 312, an unlinked organizational unit 314, a linked organizational unit 316, a first environment 318, a second environment 320, a third environment 322, a fourth environment 324, and a fifth environment 326. In some examples, the account association circuitry 101 links the first development environment 306 (e.g., a first cloud account) to the second development environment 308 (e.g., a second cloud account) where the changes made to the first development environment 306 are propagated to the example second development environment 308.

In the example of FIG. 3, the first development environment 306 is not linked to the example first production environment 310. The changes made to the first production environment 310 are not affected by the changes made to the first development environment 306 and do not affect the first development environment 306. In some examples, the account association circuitry 101 performs the association on an organizational unit level. For example, the changes made to the unlinked organizational unit 314 are propagated to the example linked organizational unit 316 and the example environments 318, 320, 322 of the linked organizational unit 316. The example fourth environment 324 is linked to the example fifth environment 326 (e.g., changes from the fourth environment 324 are propagated to the fifth environment 326), and the fifth environment 326 is linked to the fourth environment 324 (e.g., changes from the fifth environment 326 are propagated to the fourth environment 324).

FIG. 4A is a first portion of a first sequence diagram of the account association circuitry operating to associate a first cloud account to a second cloud account. The example sequence diagram includes the example user account 130, the example enforcement service 112, the example IDEM service 122, the example IDEM service worker 124, the example IDEM enforcement plugin 126, the example IDEM-events database 128, and the example configuration information database 216. An example enable association sequence 402 includes multiple operations 404, 406, 408, 410, 412, 414 416, 418, 420, 422, 424, 426 (FIG. 4B), 428 (FIG. 4B), 430 (FIG. 4B), 432 (FIG. 4B), and 434 (FIG. 4B.

At operation 404, the example user account 130 determines to enable association of one cloud account to another cloud account by transmitting an instruction to the example enforcement service 112. For example, the user account 130 may transmit an instruction to the example network interface circuitry 202 (FIG. 2) of the example account association circuitry 101 (FIG. 2). After the instruction, the enforcement service 112 performs a decision based on if the association was enabled previously for the two cloud accounts. If the example enforcement service 112 determines that there was a previous association of the two cloud accounts, the enforcement service 112 performs operation 406. Alternatively, if the example enforcement service 112 determines that there was not a previous association of the two cloud accounts, the enforcement service 112 performs operations 408, 410. The example enforcement service 112 may use the example linking circuitry 204 (FIG. 2) of the example account association circuitry 101 (FIG. 2) to determine if a previous association was recorded.

At operation 406, the example audit circuitry 214 (FIG. 2) of the example account association circuitry 101 (FIG. 2) finds all the enforcement policies (VMware's Guardrails® enforcement service guardrails) that have changed since the last time in the source account. The example audit circuitry 214 (FIG. 2) may determine the enforcement policies by determining the history of the two cloud accounts by using the linked account status database 218 (FIG. 2) of the example account association circuitry 101 (FIG. 2). In some examples, the enforcement circuitry 208 (FIG. 2) of the example account association circuitry 101 (FIG. 2) accesses a list of enforcement policy templates to determine if the templates which are applied to the reference account have been changed. After operations 406, the example enforcement service 112 performs operation 412.

At operation 408, the example linking circuitry 204 (FIG. 2) of the example account association circuitry 101 (FIG. 2) creates an account association and lists (e.g., marks, tags) the association as uninitialized. The example linking circuitry 204 (FIG. 2) of the example account association circuitry 101 (FIG. 2) of the example enforcement service 112 stores the association in the example linked account status database 218.

At operation 410, the example monitor circuitry 206 (FIG. 2) of the example account association circuitry 101 (FIG. 2) finds all the enforcement policies (e.g., VMware's Guardrails® enforcement service guardrails) that are applied to the source account (e.g., reference account).

At operation 412, the example monitor circuitry 206 (FIG. 2) creates an IDEM task to capture the configuration of the enforcement policies (e.g., VMware's Guardrails® enforcement service guardrails). The example monitor circuitry 206 (FIG. 2) of the account association circuitry 101 (FIG. 2) of the enforcement service 112 may send an IDEM task instruction to the example IDEM service 122.

At operation 414, once the example IDEM service 122 receives the IDEM task instruction, the IDEM service worker 124 retrieves (e.g., picks up) the IDEM task.

At operation 416, the example IDEM service 122 executes the IDEM process by using the example IDEM enforcement plugin 126.

At operation 418, the example IDEM enforcement plugin 126 operates in a loop until all the resources and states that are affected by the enforcement policies are processed. The example IDEM enforcement plugin 126 is to push the resource data including the change in the given resource to the example IDEM-events database 128.

At operation 420, the enforcement circuitry 208 (FIG. 2) of the example account association circuitry 101 (FIG. 2) reads the resource data for each resource. For example, the reference file that corresponds to the target state (e.g., desired state) for the configuration of the first cloud account (e.g., source account, reference account) may be stored in the example IDEM-events database 128. The example enforcement circuitry 208 (FIG. 2) uses the reference file to determine if there are deviations in the configuration of the first cloud account.

At operation 422, the example enforcement circuitry 208 (FIG. 2) of the example account association circuitry 101 (FIG. 2) writes the resource data to the configuration information database 216. For example, the enforcement circuitry 208 (FIG. 2) may correct any deviations from the reference file in the configuration of the first cloud account. The example enforcement circuitry 208 (FIG. 2) also corrects any deviations in the second cloud account which is linked to the first cloud account.

At operation 424, the example validation circuitry 212 (FIG. 2) of the example account association circuitry 101 (FIG. 2) determines if there are any conflicts by comparing the resource and the configuration of the resource.

FIG. 4B is a second portion of the first sequence diagram of the account association circuitry operating to associate the first cloud account to the second cloud account. FIG. 4B continues the enable association sequence 402. After operation 424 (FIG. 4A), the example validation circuitry 212 (FIG. 2) of the example account association circuitry 101 (FIG. 2) for resolvable conflicts, resolves the conflict at operation 426. For example, the validation circuitry 212 (FIG. 2) may use a least privilege protocol (e.g., least permission principle) to determine how to resolve a conflict.

At operation 428, in response to a non-resolvable conflict, the example exception circuitry 210 (FIG. 2) of the example account association circuitry 101 (FIG. 2) marks the association as an error in the example linked account status database 218.

At operation 430, the example exception circuitry 210 (FIG. 2) of the example account association circuitry 101 (FIG. 2) sends a message to an example user account 130 to request that the user account 130 manually resolves the conflict.

At operation 432, after the conflicts have been resolved, the example linking circuitry 204 (FIG. 2) of the example account association circuitry 101 (FIG. 2) marks the association as initialized and stores the metadata of the active enforcement policies (e.g., enforced templates) by storing the metadata in the linked account status database 218.

At operation 434, the enforcement circuitry 208 creates an enforced state when there are no more conflicts or the conflicts have been suitably resolved. For example, a suitably resolved conflict may be a conflict that is flagged for intervention from the user account 130.

The example enforced state creation and modification operation 436 includes operations 438, 440. The example user account 130 modifies (e.g., updates) the enforcement policy (e.g., VMware's Guardrails® enforcement service guardrails template) of an account against which another account is associated at the example enforcement service 112. For example, the user account 130 modifies the enforcement policy of a first cloud account (e.g., a source account, a reference account) that is associated with a second cloud account (e.g., flexible account). The example user account 130 may send an instruction to the example enforcement circuitry 208 (FIG. 2) of the example account association circuitry 101 (FIG. 2). The example enforcement service 112 determines if any of the accounts are associated. Then, the example enforcement service 112 performs operation 412 through operation 434 of the enable association sequence 402.

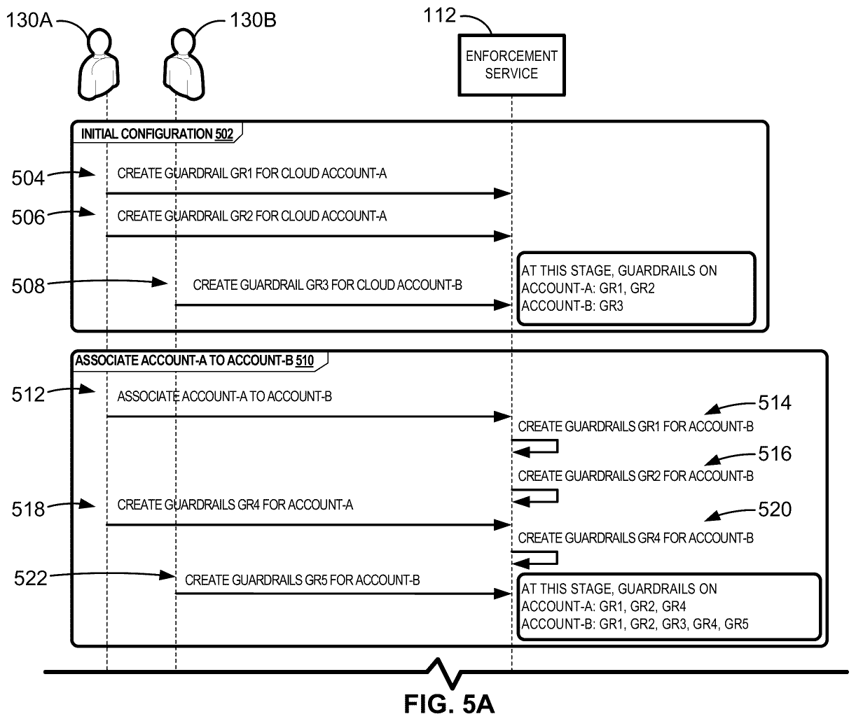

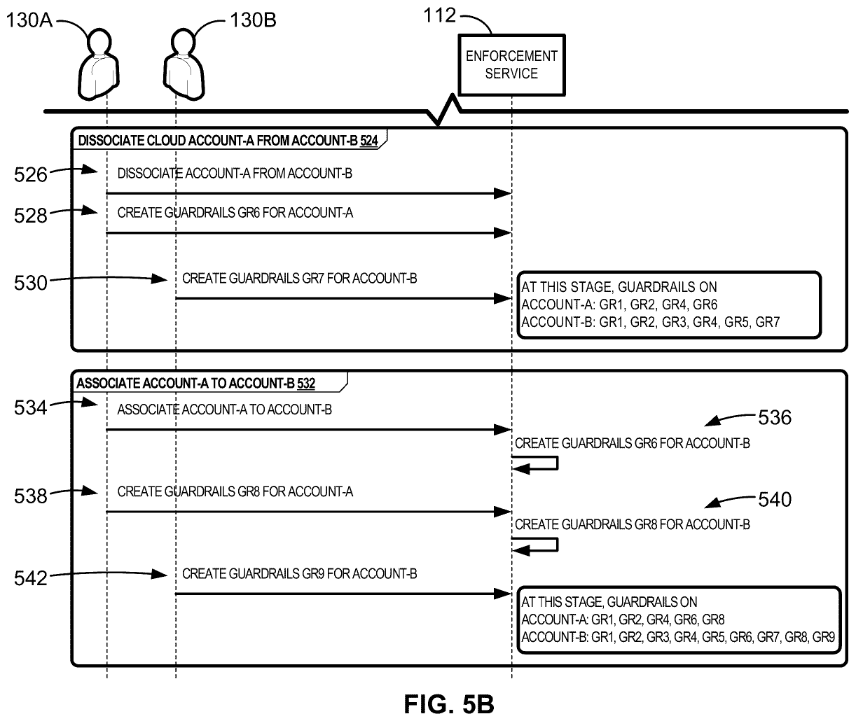

FIG. 5A is a first portion of a second sequence diagram of the account association circuitry 101 (FIG. 2) operating to associate the first cloud account to the second cloud account. The example of FIG. 5A includes a first user account 130A, a second user account 130B, and the example enforcement service 112 which includes the example account association circuitry 101 (FIG. 2). The example initial configuration sequence 502, includes three operations 504, 506, 508. At operation 504, the example first user account 130A creates a first enforcement policy (e.g., “GUARDRAIL GR1”) for a first cloud account (e.g., “CLOUD ACCOUNT-A”). At operation 506, the example first user account 130A creates a second enforcement policy (e.g., “GUARDRAIL GR2”) for the first cloud account (e.g., “CLOUD ACCOUNT-A”). At operation 508, the example second user account 130B creates a third enforcement policy (e.g., “GUARDRAIL GR3”) for the second cloud account (e.g., “CLOUD ACCOUNT-B”). At this stage, the first and second enforcement policies are assigned to the example first cloud account, and the example third enforcement policy is assigned to the example second cloud account.

The association sequence 510 includes six operations 512, 514, 516, 518, 520, 522. At operation 512, the first user account 130A determines to associate the first cloud account (e.g., “CLOUD ACCOUNT-A”) to the second cloud account (e.g., “CLOUD ACCOUNT-B”). The example linking circuitry 204 (FIG. 2) links the first cloud account and the second cloud account. The example monitor circuitry 206 (FIG. 2) determines that the configuration information of the first cloud account is different from the second cloud account. At operation 514, the example enforcement circuitry 208 (FIG. 2) applies (e.g., creates) the first enforcement policy (e.g., “GUARDRAILS GR1”) on the second cloud account (e.g., “CLOUD ACCOUNT-B”). At operation 516, the example enforcement circuitry 208 (FIG. 2) applies the second enforcement policy (e.g., “GUARDRAILS GR2”) on the second cloud account (e.g., “CLOUD ACCOUNT-B). At operation 518, the example first user account 130A creates a fourth enforcement policy (e.g., “GUARDRAILS GR4”) on the first cloud account (e.g., “CLOUD ACCOUNT-A”). The example enforcement circuitry 208 (FIG. 2) applies the fourth enforcement policy (e.g., “GUARDRAILS GR4”) on the second cloud account (e.g., “CLOUD ACCOUNT-B”). By associating the first cloud account and the second cloud account, the account association circuitry 101 (FIG. 2) is able to keep the second cloud account up to date based on changes made to the first cloud account. The example second user account 130B creates a fifth enforcement policy (e.g., “GUARDRAILS GR5”) for the second cloud account (e.g., “CLOUD ACCOUNT-B”). After operation 522 is completed, the first cloud account has the first, second, and fourth enforcement policy applied, and the example second cloud account has the first, second, third, fourth, and fifth enforcement policy applied.

FIG. 5B is a second portion of the second sequence diagram of the account association circuitry operating to associate the first cloud account to the second cloud account. The example dissociation sequence 524 includes three operations 526, 528, 530. The example dissociation sequence 524 begins at operation 526 where the first user account 130A determines to dissociate the first cloud account from the second cloud account. For example, the linking circuitry 204 (FIG. 2) removes the association (e.g., breaks the link, dissociates, removes the linked status) the first cloud account from the second cloud account. At operation 528, the example first user account 130A determines to create a sixth enforcement policy on the first cloud account. As there is no association between the first cloud account and the second cloud account, the enforcement circuitry 208 (FIG. 2) does not apply the sixth enforcement policy on the second cloud account. At operation 530, the example second user account 130B creates a seventh enforcement policy on the second cloud account. After operation 530, the example first cloud account has the example first, second, fourth, and sixth enforcement policy while the example second cloud account has the example first, second, third, fourth, fifth, and seventh enforcement policy.

The example subsequent association sequence 532 includes five operations 534, 536, 538, 540, 542. The example first user account 130A associates the first cloud account (e.g., “CLOUD ACCOUNT-A”) to the example second cloud account (e.g., “CLOUD ACCONT-B”). The example subsequent association links the enforcement policies that were applied in the interim time. After the linking circuitry 204 (FIG. 2) associates the first cloud account to the second cloud account, the example monitor circuitry 206 determines the enforcement policies that are currently on the first cloud account and the second cloud account. At operation 540, in response to a determination from the monitor circuitry 206 (FIG. 2), the example enforcement circuitry 208 (FIG. 2) applies the sixth enforcement policy (e.g., “GUARDRAILS GR6”) to the second cloud account (e.g., “CLOUD ACCOUNT-B”). At operation 538, the example first user account 130A creates an eighth enforcement policy (e.g., “GUARDRAILS GR8”) for the first cloud account (e.g., “CLOUD ACCOUNT-A”). At operation 540, the example enforcement circuitry 208 (FIG. 2) creates the eighth enforcement policy (e.g., “GUARDRAILS GR8”) on the second cloud account (e.g., “CLOUD ACCOUNT-B”). At operation 542, the example second user account 130B creates a ninth enforcement policy (e.g., “GUARDRAILS GR9”) for the second cloud account (e.g., “CLOUD ACCOUNT-B”). The example enforcement circuitry 208 (FIG. 2) then applies the ninth enforcement policy on the second cloud account. After operation 542, the example first cloud account has the example first, second, fourth, sixth, and eighth enforcement policies while the example second cloud account has the example first, second, third, fourth, fifth, sixth, seventh, eighth, and ninth enforcement policy.

A flowchart representative of example machine readable instructions, which may be executed by programmable circuitry to implement and/or instantiate the account association circuitry 101 of FIG. 2 and/or representative of example operations which may be performed by programmable circuitry to implement and/or instantiate the account association circuitry 101 of FIG. 2, is shown in FIG. 6. The machine readable instructions may be one or more executable programs or portion(s) of one or more executable programs for execution by programmable circuitry such as the programmable circuitry 712 shown in the example programmable circuitry platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 6, many other methods of implementing the example account association circuitry 101 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by example programmable circuitry to implement the account association circuitry 101 of FIG. 2 to link a first cloud account and a second cloud account. The example machine-readable instructions and/or the example operations 600 of FIG. 6 begin at block 602, at which the example network interface circuitry 202 (FIG. 2) monitors user requests. For example, the network interface circuitry 202 (FIG. 2) may monitor user requests by using the linking circuitry 204 (FIG. 2).

At block 604, the example linking circuitry 204 (FIG. 2) determines if a user request is received. For example, in response to the linking circuitry 204 (FIG. 2) determining that a user request is received (e.g., “YES”), control advances to block 606. Alternatively, in response to the linking circuitry 204 (FIG. 2) determining that a user request is not received (e.g., “NO”), control returns to block 602. For example, the linking circuitry 204 (FIG. 2) may sort network communications received by the network interface circuitry 202 (FIG. 2).

At block 606, the example linking circuitry 204 (FIG. 2) determines if the user request is a linking request. For example, in response to the linking circuitry 204 (FIG. 2) determining that the user request is a linking request (e.g., “YES”), control advances to block 610. Alternatively, in response to the linking circuitry 204 (FIG. 2) determining that the user request is not a linking request (e.g., “NO”), control advances to block 608. For example, the user request may be a linking request (e.g., a request to associate a first cloud account and a second cloud account) or may be an unlinking request (e.g., a request to remove an association between a first cloud account and a second cloud account).

At block 608, the example linking circuitry 204 (FIG. 2) removes the association between the first cloud account and the second cloud account. For example, the linking circuitry 204 (FIG. 2) may delete the association from the example linked account status database 218 (FIG. 2). Now that the association between the two cloud accounts has been removed, changes made to the first cloud account are not propagated to the second cloud account. The example second cloud account may have further enforcement policies applied or be linked to an example third cloud account. After block 608, control returns to block 602.

At block 610, the example linking circuitry 204 (FIG. 2) stores an association. For example, the linking circuitry 204 (FIG. 2) may store an association that links a first cloud account to a second cloud account. In some examples, the linking circuitry 204 (FIG. 2) may store an association that links the second cloud account to the first cloud account. In some examples, the audit circuitry 214 (FIG. 2) may be used to store the association in the example linked account status database 218 (FIG. 2). In some examples, a user account may request which cloud accounts are linked to other cloud accounts. The example audit circuitry 214 (FIG. 2) (FIG. 2) will retrieve the stored associations and a record of a time periods that the different cloud accounts were linked to other cloud accounts.

At block 612, the example monitor circuitry 206 (FIG. 2) monitors the first cloud account. For example, the monitor circuitry 206 (FIG. 2) may monitor the configuration information of the first cloud account. In some examples, a user may attempt to directly update or change the configuration of the first cloud account. In such examples, enforcement circuitry 208 (FIG. 2) may reset the configuration of the first cloud account to match a target state (e.g., desired state) if the update to the configuration of the first cloud account does not match the target state. In some examples, a user may update the target state of the first cloud account. In such examples, the enforcement circuitry 208 (FIG. 2) changes the configuration of the first cloud account to match the updated target state.

At block 614, the example monitor circuitry 206 (FIG. 2) determines if a configuration change in the first cloud account is detected. For example, if the monitor circuitry 206 (FIG. 2) determines that a configuration change in the first cloud account is detected (e.g., “YES”), control advances to block 616. Alternatively, in response to the monitor circuitry 206 (FIG. 2) determining that a configuration change in the first cloud account is not detected (e.g., “NO”), control returns to block 612. For example, if an enforcement policy is added to the target state of the first cloud account, and the configuration information is updated to reflect the additional enforcement policy, the example monitor circuitry 206 (FIG. 2) determines that the configuration information changed in the first cloud account.

At block 616, the example enforcement circuitry 208 (FIG. 2) applies the change in the configuration of the first cloud account to the second cloud account. For example, the enforcement circuitry 208 (FIG. 2) may apply an enforcement policy that is recently added to the configuration information of the first cloud account to the second cloud account.

At block 618, the example validation circuitry 212 (FIG. 2) determines if a conflict in applying the configuration change to the second cloud account is detected. For example, in response to the validation circuitry 212 (FIG. 2) determining that no conflict is detected (e.g., “NO”), control advances to block 626. Alternatively, in response to the validation circuitry 212 (FIG. 2) determining that a conflict is detected (e.g., “YES”), control advances to block 620.

At block 620, after the validation circuitry 212 (FIG. 2) determines that a conflict between the first cloud account and the second cloud account exists, the example validation circuitry 212 (FIG. 2) determines if the conflict is resolvable. For example, if the validation circuitry 212 (FIG. 2) determines that the conflict is resolvable (e.g., “YES”), control advances to block 622. Alternatively, if the validation circuitry 212 (FIG. 2) determines that the conflict is not resolvable (e.g., “NO”), control advances to block 624.

At block 622, the example validation circuitry 212 (FIG. 2) resolves the conflict with a least privilege protocol. For example, the validation circuitry 212 (FIG. 2) may resolve the conflict by determining a privilege level of the first user (e.g., a super user, a developer, an operations team member, an analyst, or a system account, etc.) and a privilege level of the second user. For example, if the first user account has a super user status with a higher privilege level than a second user account, then the conflict between the configuration information of the cloud accounts can be resolved by the example validation circuitry 212 (FIG. 2) by following the instruction from the first user account. Control advances to block 626.

At block 624, the example exception circuitry 210 (FIG. 2) flags the conflict for a first user account. For example, the exception circuitry 210 (FIG. 2) may notify the first user account that the first user account has the same privilege level as a second user account. The example exception circuitry 210 (FIG. 2) informs the first user account that the least privilege protocol is unable to be used by the validation circuitry 212 (FIG. 2) to resolve the conflict because of the same privilege level. The example exception circuitry 210 (FIG. 2) may receive an instruction from the first user account on which configuration information change in the cloud accounts is to be applied. Control advances to block 626.

At block 626, the example monitor circuitry 206 (FIG. 2) determines to continue monitoring the first cloud account. For example, in response to the monitor circuitry 206 (FIG. 2) determining to continue monitoring the first cloud account (e.g., “YES”), control returns to block 612. Alternatively, in response to the monitor circuitry 206 (FIG. 2) determining to not continue monitoring the first cloud account (e.g., “NO”), control advances to block 628.

At block 628, the linking circuitry 204 (FIG. 2) determines whether to continue monitoring for user requests. For example, in response to the linking circuitry 204 (FIG. 2) determining to continue monitoring for user requests (e.g., “YES”), control returns to block 602. Alternatively, in response to the linking circuitry 204 (FIG. 2) determining not to continue monitoring for user requests, the instructions 600 end.

FIG. 7 is a block diagram of an example programmable circuitry platform 700 structured to execute and/or instantiate the example machine-readable instructions and/or the example operations of FIG. 6 to implement the account association circuitry 101 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example network interface circuitry 202, the example linking circuitry 204, the example monitor circuitry 206, the example enforcement circuitry 208, the example exception circuitry 210, the example validation circuitry 212, and the example audit circuitry 214.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIG. 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIG. 6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIG. 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 6. As such, the FPGA circuitry 900 may be configured and/or structured to effectively instantiate some or all of the operations/functions corresponding to the machine readable instructions of the flowchart(s) of FIG. 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIG. 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIG. 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIG. 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 6, and/or an ASIC may be configured and/or structured to perform third operation(s)/function(s) corresponding to a third portion of the machine readable instructions represented by the flowcharts of FIG. 6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

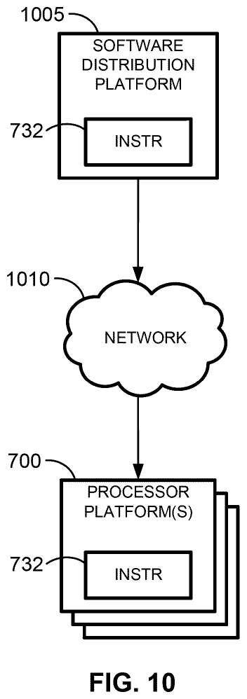

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIG. 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 6, may be downloaded to the example programmable circuitry platform 700, which is to execute the machine readable instructions 732 to implement the account association circuitry 101. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that associate cloud accounts. Disclosed systems, apparatus, articles of manufacture, and methods improve the efficiency of using a computing device by reducing manual associations performed by a user to multiple cloud accounts. If a small change is made to a development account, multiple production accounts that are linked to the development account, because of the disclosed systems, apparatus, articles of manufacture, and methods, can be automatically updated to correspond to the updated configuration state of the development account. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for association of cloud accounts are disclosed herein. Further examples and combinations thereof include the following: Example 1 includes an apparatus including network interface circuitry, machine-readable instructions, and programmable circuitry to at least one of instantiate or execute the machine-readable instructions to in response to a linking request, associate a first cloud account and a second cloud account, where the association causes changes made to the first cloud account to be propagated to the second cloud account, store the association in a database, monitor a configuration of the first cloud account, and after a change in configuration information of the first cloud account, apply the configuration information corresponding to the first cloud account to the second cloud account.

Example 2 includes the apparatus of example 1, wherein the change in the configuration information of the first cloud account is an updated enforcement policy applied on the first cloud account.

Example 3 includes the apparatus of example 2, wherein the updated enforcement policy is applied on the second cloud account based on the association of the first cloud account and the second cloud account.

Example 4 includes the apparatus of example 3, wherein a plurality of enforcement policies are applied on the first cloud account, and the programmable circuitry is to determine if a first one of the enforcement policies is currently applied to the second cloud account.

Example 5 includes the apparatus of example 4, wherein the programmable circuitry is to, in response to the first one of the enforcement policies being applied to the second cloud account, notify a user of a conflict in the configuration.

Example 6 includes the apparatus of example 4, wherein the programmable circuitry is to, in response to the first one of the enforcement policies being applied to the second cloud account, resolve a conflict in the configuration based on a privilege protocol.

Example 7 includes the apparatus of example 1, wherein after a request to remove a linked status between the first cloud account and the second cloud account, the programmable circuitry is to remove the association from the database.

Example 8 includes the apparatus of example 7, wherein after the linked status is removed, the programmable circuitry applies a second enforcement policy to the first cloud account, the second enforcement policy not applied to the second cloud account.

Example 9 includes the apparatus of example 8, wherein after a subsequent association of the first cloud account and the second cloud account, the programmable circuitry applies the second enforcement policy to the second cloud account.

Example 10 includes the apparatus of example 1, wherein the programmable circuitry is to compare the configuration information of the first cloud account to configuration information of the second cloud account.

Example 11 includes the apparatus of example 1, wherein after a third cloud account is associated to a second cloud account, the programmable circuitry is to apply the configuration information of the first cloud account and the configuration information to the second cloud account to the third cloud account.

Example 12 includes a non-transitory machine-readable storage medium including instructions to cause programmable circuitry to at least in response to a linking request, associate a first cloud account and a second cloud account, where the association causes changes made to the first cloud account to be propagated to the second cloud account, store the association in a database, monitor a configuration of the first cloud account, and after a change in configuration information of the first cloud account, apply the configuration information corresponding to the first cloud account to the second cloud account.

Example 13 includes the storage medium of example 12, wherein the change in the configuration information of the first cloud account is an updated enforcement policy applied on the first cloud account.

Example 14 includes the storage medium of example 13, wherein the updated enforcement policy is applied on the second cloud account based on the association of the first cloud account and the second cloud account.

Example 15 includes the storage medium of example 14, wherein a plurality of enforcement policies are applied on the first cloud account, and the programmable circuitry is further to determine if a first one of the enforcement policies is currently applied to the second cloud account.

Example 16 includes the storage medium of example 12, wherein after a request to remove a linked status between the first cloud account and the second cloud account, the programmable circuitry is to remove the association from the database.

Example 17 includes an apparatus including network interface circuitry to retrieve a linking request, linking circuitry to associate a first cloud account and a second cloud account, where the association causes changes made to the first cloud account to be propagated to the second cloud account, and store the association in a database, monitor circuitry to monitor first configuration information of the first cloud account, and enforcement circuitry to apply the first configuration information to the second cloud account after a change in the first configuration information.

Example 18 includes the apparatus of example 17, further including validation circuitry to compare the first configuration information to second configuration information, the second configuration information corresponding to the second cloud account.

Example 19 includes the apparatus of example 18, further including exception circuitry to notify a user after a conflict between the first configuration information and the second configuration information is detected.

Example 20 includes the apparatus of example 17, further including audit circuitry to provide a list of enforcement policies applied on the first cloud account and the second cloud account.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a network interface circuitry;
machine-readable instructions; and
a programmable circuitry to at least one of instantiate or execute the machine-readable instructions to:
in response to a linking request, associate a first cloud account and a second cloud account, where an association causes changes made to the first cloud account to be propagated to the second cloud account;
store the association in a database;
monitor a configuration of the first cloud account; and
after a change in configuration information of the first cloud account, apply the configuration information corresponding to the first cloud account to the second cloud account.

2. The apparatus of claim 1, wherein the change in the configuration information of the first cloud account is an updated enforcement policy applied on the first cloud account.

3. The apparatus of claim 2, wherein the updated enforcement policy is applied on the second cloud account based on the association of the first cloud account and the second cloud account.

4. The apparatus of claim 3, wherein a plurality of enforcement policies are applied on the first cloud account, and the programmable circuitry is to determine if a first one of the enforcement policies is currently applied to the second cloud account.

5. The apparatus of claim 4, wherein the programmable circuitry is to, in response to the first one of the enforcement policies being applied to the second cloud account, notify a user of a conflict in the configuration.

6. The apparatus of claim 4, wherein the programmable circuitry is to, in response to the first one of the enforcement policies being applied to the second cloud account, resolve a conflict in the configuration based on a privilege protocol.

7. The apparatus of claim 1, wherein after a request to remove a linked status between the first cloud account and the second cloud account, the programmable circuitry is to remove the association from the database.

8. The apparatus of claim 7, wherein after the linked status is removed, the programmable circuitry applies a second enforcement policy to the first cloud account, the second enforcement policy not applied to the second cloud account.

9. The apparatus of claim 8, wherein after a subsequent association of the first cloud account and the second cloud account, the programmable circuitry applies the second enforcement policy to the second cloud account.

10. The apparatus of claim 1, wherein the programmable circuitry is to compare the configuration information of the first cloud account to configuration information of the second cloud account.

11. The apparatus of claim 1, wherein after a third cloud account is associated to a second cloud account, the programmable circuitry is to apply the configuration information of the first cloud account and the configuration information to the second cloud account to the third cloud account.

12. A non-transitory machine-readable storage medium comprising instructions to cause a programmable circuitry to at least:
in response to a linking request, associate a first cloud account and a second cloud account, where an association causes changes made to the first cloud account to be propagated to the second cloud account;
store the association in a database;
monitor a configuration of the first cloud account; and
after a change in configuration information of the first cloud account, apply the configuration information corresponding to the first cloud account to the second cloud account.

13. The non-transitory machine-readable storage medium of claim 12, wherein the change in the configuration information of the first cloud account is an updated enforcement policy applied on the first cloud account.

14. The non-transitory machine-readable storage medium of claim 13, wherein the updated enforcement policy is applied on the second cloud account based on the association of the first cloud account and the second cloud account.

15. The non-transitory machine-readable storage medium of claim 14, wherein a plurality of enforcement policies are applied on the first cloud account, and the programmable circuitry is further to determine if a first one of the enforcement policies is currently applied to the second cloud account.

16. The non-transitory machine-readable storage medium of claim 12, wherein after a request to remove a linked status between the first cloud account and the second cloud account, the programmable circuitry is to remove the association from the database.

17. An apparatus comprising:
a network interface circuitry to retrieve a linking request;
a linking circuitry to:
associate a first cloud account and a second cloud account, where an association causes changes made to the first cloud account to be propagated to the second cloud account; and
store the association in a database;
a monitor circuitry to monitor a first configuration information of the first cloud account; and
an enforcement circuitry to apply the first configuration information to the second cloud account after a change in the first configuration information.

18. The apparatus of claim 17, further including validation circuitry to compare the first configuration information to second configuration information, the second configuration information corresponding to the second cloud account.

19. The apparatus of claim 18, further including exception circuitry to notify a user after a conflict between the first configuration information and the second configuration information is detected.

20. The apparatus of claim 17, further including audit circuitry to provide a list of enforcement policies applied on the first cloud account and the second cloud account.
